(19) United States
(12) Patent Application Publication
(10) Pub. No.: US 2002/0015586 A1
(43) Pub. Date: Feb. 7, 2002

(54) Rotatable integral wiring enclosure

(75) Inventors: Sid Furlong, Ogden, UT (US); Ed Zelazny, Ogden, UT (US); Joey Anderson, Taylorsville, UT (US)

Correspondence Address: HOWREY SIMON ARNOLD & WHITE, 750 Bering Drive, Houston, TX, 77057-2198, US

(73) Assignee: Emerson Electric Company

(21) Appl. No.: 09/878,624

(22) Filed: Jun. 11, 2001

Related U.S. Application Data
(60) Provisional application No. 60/211,045, filed on Jun. 12, 2000.

(51) Int. Cl. H05B 3/00

(52) U.S. Cl. 392/501; 219/536

(57) ABSTRACT

A rotatable integral wiring enclosure. In one embodiment, the invention comprises a rotatable integral wiring enclosure comprising: (a) an enclosure base having an opening larger than the diameter of an external threaded plug affixed to or forming the base of a heater; (b) a locknut having an inner and outer diameter, wherein the outer diameter is larger than the enclosure base opening and the inner diameter is threaded to screw onto the external threaded plug; and (c) a cover adapted to attach to the enclosure base, wherein after inserting the external threaded plug through the enclosure base opening and screwing the locknut onto the external threaded plug the enclosure base is both captive and capable of rotating about the external threaded plug independently of the heater and locknut prior to fully tightening the locknut.

### CROSS REFERENCE TO RELATED APPLICATIONS

This application claims the benefit of U.S. Provisional Application No. 60/211,045, filed Jun. 12, 2000. This Provisional Application is hereby incorporated herein by reference in its entirety.

### FIELD OF THE INVENTION

This invention relates generally to heater wiring enclosures and more particularly, to adjustable heater wiring enclosures.

### BACKGROUND OF THE INVENTION

Heating stagnant and circulating mediums, e.g., liquid, gas, steam, air, in containers, e.g., tanks, reservoirs, pipes, are common industrial practices for numerous reasons. Heating may be required to maintain a certain viscosity of heavy oils or resins that allow them to be readily pumped. Heating may also prevent crystalline precipitation or freezing during the process, or may simply facilitate the process itself.

An immersion heater represents one type of heater used to heat mediums. An immersion heater, such as a screw plug or flanged heater, has a protruding heating element, for insertion through a bore hole in a container wall, a base, for mounting to or within the bore, and electrical terminals for connecting to a power source. In this way, the heating elements extend within the container, the base seals the hole, and the electrical terminals for the heating elements are accessible outside the container wall.

Circulation heaters consist of a screw plug or flanged type immersion heater mounted in a thermally insulated heating chamber with input and output terminals for a circulating medium. Circulation heaters are designed to efficiently heat flowing mediums. Circulation heaters must be capable of withstanding the high pressures and temperatures of the heated mediums.

The difficulty presented by field applications of immersion heaters is that each application may call for different wiring orientations. It is of great utility to have a single design which can adapt to the widest number of applications. One such design is described in commonly assigned U.S. Pat. No. 5,528,722 (“the '722 patent”). The '722 patent describes a relatively complex rotatable electrical enclosure for a heater requiring a separate mounting ring, screw holes in the ring and the screw plug or flange style base, screws to join them and the electrical enclosure, together.

Simplification of existing products would likely result in lower costs, fewer manufacturing steps, fewer parts, fewer small parts susceptible to being dropped and/or lost, and easier installation of heaters and enclosures. Either alone or in combination such results would be a useful improvement. Therefore there is a need to simplify the existing products while retaining the benefits of an independently rotatable electrical enclosure.

The present invention is directed to overcoming, or at least reducing the effects of, one or more of the problems set forth above.

### SUMMARY OF THE INVENTION

A rotatable integral wiring enclosure. In one embodiment, the invention comprises a rotatable integral wiring enclosure comprising: (a) an enclosure base having an opening larger than the diameter of an external threaded plug affixed to or forming the base of a heater; (b) a locknut having an inner and outer diameter, wherein the outer diameter is larger than the enclosure base opening and the inner diameter is threaded to screw onto the external threaded plug; and (c) a cover adapted to attach to the enclosure base, wherein after inserting the external threaded plug through the enclosure base opening and screwing the locknut onto the external threaded plug the enclosure base is both captive and capable of rotating about the external threaded plug independently of the heater and locknut prior to fully tightening the locknut.

### BRIEF DESCRIPTION OF THE DRAWINGS

The foregoing and other features and aspects of the present invention will be best understood with reference to the following detailed description of specific embodiments of the invention, when read in conjunction with the accompanying drawings, wherein:

FIG. 1 displays an exploded view of a rotatable heater enclosure in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF EMBODIMENTS OF THE INVENTION

In the disclosure that follows, in the interest of clarity, not all features of actual implementations are described. It will of course be appreciated that in the development of any such actual implementation, as in any such project, numerous engineering and design decisions must be made to achieve the developers' specific goals and subgoals (e.g. compliance with mechanical and business-related constraints), which will vary from one implementation to another. Moreover, attention will necessarily be paid to proper engineering and design practices for the environment in question. It will be appreciated that such a development effort might be complex and time-consuming, but would nevertheless be a routine undertaking for those of skill in the art.

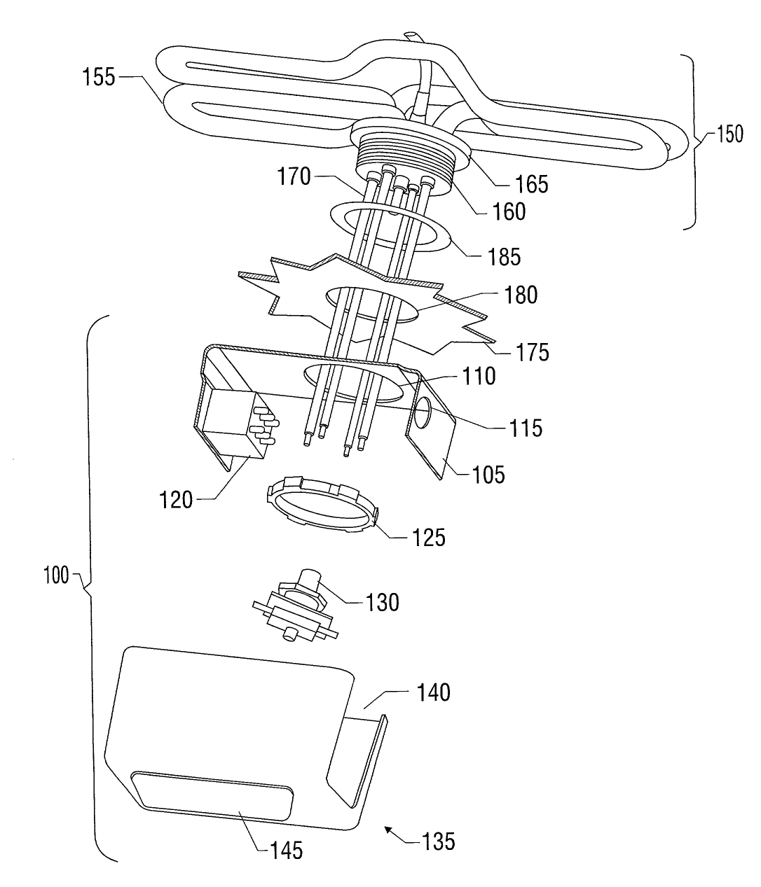

In accordance with the invention, FIG. 1 displays an exploded view of a rotatable screw plug enclosure. Rotatable enclosure 100 comprises cover 135, temperature sensor cutout with reset 130, locknut 125, base 105, and relay 120. Heater 150 comprises heating element bundle 155, screw plug 160 with flange 165 and electrical conductors 170 for heating element bundle 155.

To assemble heater 150 to rotatable enclosure 100, heater 150 is inserted into a container which will contain the medium requiring heating (not completely shown), and be pushed through an opening in a container wall, i.e., container opening 175. Gasket 185 fits around screw plug 160 and against flange 165 of heater 150 to seal container opening 180. After being pushed through container opening 180 electrical conductors 170 and a portion of screw plug 160 are accessible for further assembly. Base 105 is slipped over electrical conductors 170 and screw plug 160 by guiding them through base opening 110. Electrical conductors 170 are next guided through locknut 125. Locknut 125 is partially screwed onto the external portion of screw plug 160 to capture base 105 and heater 150 by preventing heater 150 from slipping inside the container. Base 105 is captured so long as the exterior dimension of locknut 125 is larger than base opening 110.

While locknut 125 is not finally tightened, base 105 freely rotates around and independent of screw plug 160. This allows base 105 to be positioned so that conduit opening 115 is aligned with incoming conduit (not shown). Once base 105 is in position, locknut 125 is tightened to fix in place heater 150 and base 105. Tightening locknut 125 also serves to seal container opening 180 by drawing flange 165 and gasket 185 against the inside of the container. Next, as is well known in the art, conduit (not shown) and electrical conductors 170 would be wired to relay 120 and temperature sensor cutout with manual reset 130 would be installed. Finally cover 135 would be positioned over base 105 and be snapped, or otherwise affixed, thereto such that cover opening 140 is aligned with conduit opening 115. A window or nameplate 145 may be utilized as necessary.

The invention is similarly applicable to screw plug and flanged heaters which may be inserted into a container's heater opening from outside the container (as opposed to being inserted through the heater opening from inside the container as depicted in FIG. 1), provided the screw plug or flanged heater has an exterior screw plug to adapt to a locknut. Heater element electrical conductors would simply extend out of the external screwplug. Such heaters may be captured and sealed to a container before assembling the rotatable integral wiring enclosure. In other words, the locknut would not be necessary to simultaneously secure or capture the heater and the base as is depicted in FIG. 1. The rotatable enclosure would be assembled in essentially the same way shown in FIG. 1 with the same result, wherein the base rotates independent of the heater and locknut until the locknut is fully tightened.

Likewise, the invention applies to screw plug and flanged heaters used with circulation heaters, provided the screw plug or flanged heaters have an exterior screw plug to adapt to a locknut. Heater element electrical conductors would simply extend out of the external screwplug. Again, the locknut would not be needed to simultaneously secure the heater and the base, but would secure the base and allow it to be freely rotated about the exterior screw plug independent of the heater and locknut.

Rotatable integral wiring enclosures in accordance with the disclosed invention eliminate at least five components, most notably small and easily lost or dropped components, relative to the rotatable enclosure described in the '722 patent, hereby incorporated herein by reference in its entirety. Further, rotatable integral wiring enclosures in accordance with the invention require fewer manufacturing steps and fewer installation steps. Each of these improvements also translate into cost savings.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A rotatable integral wiring enclosure comprising:
(a) An enclosure base having an opening larger than the diameter of an external threaded plug affixed to or forming the base of a heater;
(b) a locknut having an inner and outer diameter, wherein the outer diameter is larger than the enclosure base opening and the inner diameter is threaded to screw onto the external threaded plug; and
(c) a cover adapted to attach to the enclosure base, wherein after inserting the external threaded plug through the enclosure base opening and screwing the locknut onto the external threaded plug the enclosure base is both captive and capable of rotating about the external threaded plug independently of the heater and locknut prior to fully tightening the locknut.

2. The rotatable integral wiring enclosure of claim 1, wherein the heater is a screw plug style heater.

3. The rotatable integral wiring enclosure of claim 1, wherein the heater is a flanged style heater.

4. The rotatable integral wiring enclosure of claim 2, wherein screwing the locknut onto the external threaded plug simultaneously captures both the heater and the enclosure base.

5. A rotatable integral wiring enclosure comprising:
(a) An enclosure base having an opening larger than the diameter of an external threaded plug affixed to or forming the base of a heater; and
(b) a locknut having an inner and outer diameter, the outer diameter being larger than the enclosure base opening and the inner diameter being threaded to screw onto the external threaded plug, wherein after inserting the external threaded plug through the enclosure base opening and screwing the locknut onto the external threaded plug the enclosure base is both captive and capable of rotating about the external threaded plug independently of the heater and locknut prior to fully tightening the locknut.

6. The rotatable integral wiring enclosure of claim 5, wherein the heater is a screw plug style heater.

7. The rotatable integral wiring enclosure of claim 5, wherein the heater is a flanged style heater.

8. The rotatable integral wiring enclosure of claim 6, wherein screwing the locknut onto the external threaded plug simultaneously captures both the heater and the enclosure base.
